(19) United States
(12) Patent Application Publication
(10) Pub. No.: US 2025/0067905 A1
(43) Pub. Date: Feb. 27, 2025

(54) DISPLAY DEVICE AND METHOD OF MANUFACTURING THE SAME

(71) Applicant: Samsung Display Co., LTD., Yongin-si (KR)

(72) Inventor: JONGHWAN CHO, Yongin-si (KR)

(73) Assignee: Samsung Display Co., LTD., Yongin-si (KR)

(21) Appl. No.: 18/808,292

(22) Filed: Aug. 19, 2024

(30) Foreign Application Priority Data
Aug. 25, 2023 (KR) 10-2023-0111863
Feb. 15, 2024 (KR) 10-2024-0022147

(51) Int. Cl. G02B 1/14; B05D 1/00; G06F 1/16

(52) U.S. Cl. CPC G02B 1/14; B05D 1/60; G06F 1/1616; G06F 1/1656; B05D 2350/60; B05D 2506/00

(57) ABSTRACT

A display device includes a display panel that displays images, a window layer disposed on the display panel, and a protective film disposed on the window layer, and including a base layer facing the window layer, a hard coating layer disposed on the base layer, and a refractive layer disposed on the hard coating layer and including an organic compound including difluorocarbene (—CF₂) and trifluoromethyl group (—CF₃).

### CROSS-REFERENCE TO RELATED APPLICATION(S)

This application claims priority to and benefits of Korean Patent Application No. 10-2023-0111863, filed on Aug. 25, 2023, and Korean Patent Application No. 10-2024-0022147 under 35 U.S.C. § 119, filed on Feb. 15, 2024, in the Korean Intellectual Property Office (KIPO), the entire content of which are incorporated herein by reference.

### BACKGROUND

### 1. Field

The disclosure relates to a display device that provides visual information and a method of manufacturing the same.

### 2. Discussion of the Background

The thin display device is implemented in the form of a touch screen panel and is used in various smart devices, including smartphones, tablet PCs, and various wearable devices. These touch screen panel-based display devices have a window cover made of tempered glass on the display panel to protect the display panel from scratches or external impacts.

The optical film applied to the window cover film of the recently developed foldable display and flexible display requires high mechanical strength to replace glass and should not leave marks even when maintained in a deformed state such as folding and bending. In addition, in case that a user uses a foldable display, attempts to increase visibility by minimizing reflection of external light continue.

### SUMMARY

Embodiments provide a display device with improved display quality.

Embodiments provide a method of manufacturing the display device with improved display quality.

A display device according to an embodiment of the disclosure may include a display panel that displays images, a window layer disposed on the display panel, and a protective film disposed on the window layer, and including a base layer facing the window layer, a hard coating layer disposed on the base layer and a refractive layer disposed on the hard coating layer and including an organic compound including difluorocarbene (—CF₂) and trifluoromethyl group (—CF₃).

In an embodiment, a molar ratio of the difluorocarbene (—CF₂) and the trifluoromethyl group (—CF₃) may be about 2:1.

In an embodiment, the organic compound may include dodecafluorohepttyl acrylate (DFHA) represented by Formula 1 below:

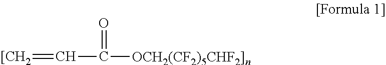

n may be one of 6, 8, 10, and 12.

In an embodiment, a thickness of the refractive layer may be in a range of about 70 nm to about 130 nm.

In an embodiment, the refractive layer may be a single layer.

In an embodiment, the refractive layer may further include a crosslinking agent.

In an embodiment, the crosslinking agent may be zinc diacrylate (ZDA).

In an embodiment, a reflectance of the protective film may be less than or equal to about 2% for light with a wavelength of about 550 nm.

In an embodiment, an elastic strain of the protective film may be in a range of about 7% to about 30%.

In an embodiment, a water contact angle of the refractive layer may be in a range of about 100 degrees to about 125 degrees.

In an embodiment, the organic compound may further include an ether group (—O—).

In an embodiment, the organic compound may include DFHA represented by Formula 1 below and perfluoropolyether (PFPE) represented by Formula 2 below.

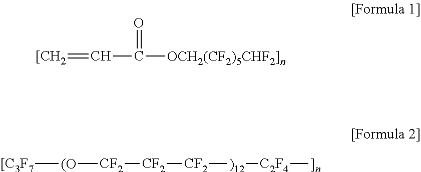

In Formula 1, n may be one of 6, 8, 10, and 12, and in Formula 2, n may be one of 10, 12, 14, and 16.

In an embodiment, the refractive layer may include a first refractive layer including DFHA, a second refractive layer disposed on the first refractive layer and including PFPE, and a mixed layer disposed between the first refractive layer and the second refractive layer and including DFHA and PFPE.

A method of manufacturing a display device according to an embodiment of the disclosure may include forming a display panel that display an image, forming a window layer on the display panel, forming a protective film including a base layer on the window layer, a hard coating layer on the base layer and a refractive layer on the hard coating layer and including an organic compound including difluorocarbene (—CF2) and trifluoromethyl group (—CF3), and attaching the protective film to the window layer.

In an embodiment, a molar ratio of the difluorocarbene (—CF2) and the trifluoromethyl group (—CF3) may be about 2:1.

In an embodiment, the organic compound may include dodecafluoroheptyl acrylate (DFHA) represented by Formula 1 below,

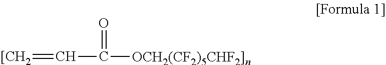

n may be one of 6, 8, 10, and 12.

In an embodiment, a reflectance of the protective film may be less than or equal to about 2% for light with a wavelength of about 550 nm.

In an embodiment, in the forming of the protective film, the refractive layer may be formed by a vacuum deposition method.

In an embodiment, the forming of the protective film may include mounting the base layer and the hard coating layer on a substrate in a vacuum chamber, supplying a gas including an argon and an organic compound including the difluorocarbene (—CF2) and the trifluoromethyl group (—CF3) to the vacuum chamber, ionizing and accelerating the gas, and forming the refractive layer by impacting the gas with the organic compound on the base layer and the hard coating layer.

In an embodiment, in the ionizing and accelerating of the gas, an acceleration voltage of the gas may be in a range of about 100V to about 500V.

Accordingly, resistance to elastic strain due to external impact, etc. is improved, so the elastic strain may be increased, and the reflectance of light may be decreased. In other words, in case that the protective film is attached to a display device, external impact and visibility of the device may be improved while using the device.

### BRIEF DESCRIPTION OF THE DRAWINGS

The accompanying drawings, which are included to provide a further understanding of the disclosure and are incorporated in and constitute a part of this specification, illustrate embodiments of the disclosure together with the description.

FIG. 1 is a perspective view of an electronic device according to an embodiment of the disclosure.

FIG. 2 is a perspective view showing the folded state of the electronic device shown in FIG. 1.

FIG. 3 is an exploded perspective view of the electronic device shown in FIG. 1.

FIG. 4 is a schematic cross-sectional view of a display device shown in FIG. 3 taken along line I-I′.

FIG. 5 is a schematic cross-sectional view showing an embodiment of the refractive layer shown in FIG. 4.

FIGS. 6 and 7 are schematic views for explaining a method of manufacturing display device of FIG. 4.

FIGS. 8 and 9 are schematic views for explaining the manufacturing process of the protective film of FIG. 4 using a vacuum deposition apparatus.

### DETAILED DESCRIPTION OF THE EMBODIMENTS

Illustrative, non-limiting embodiments will be more clearly understood from the following detailed description in conjunction with the accompanying drawings.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

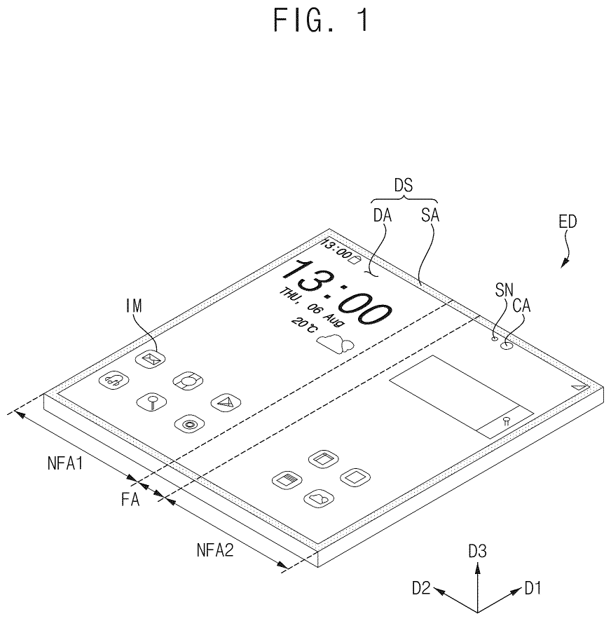

FIG. 1 is a perspective view of an electronic device according to an embodiment of the disclosure.

Referring to FIG. 1, an electronic device ED according to an embodiment of the disclosure may have a rectangular shape including long sides extending in a first direction DI and short sides extending in a second direction D2 intersecting the first direction DI in a plan view. However, the disclosure is not limited thereto, and the electronic device ED may have various shapes such as square, circular, and polygonal. The electronic device ED may be a flexible display device.

Hereinafter, a direction that substantially perpendicularly intersects the plane defined by the first direction D1 and the second direction D2 may be defined as the third direction D3.

The electronic device ED may include a folding area FA and multiple non-folding areas NFA1 and NFA2 adjacent to the folding area FA. The non-folding areas NFA1 and NFA2 may include a first non-folding area NFA1 and a second non-folding area NFA2. The folding area FA may be disposed between the first non-folding area NFA1 and the second non-folding area NFA2. The folding area FA, the first non-folding area NFA1, and the second non-folding area NFA2 may be arranged in the second direction D2.

A top surface of the electronic device ED may be defined as a display surface DS, and the display surface DS may include a plane defined by the first direction D1 and the second direction D2. Images IM generated by the electronic device ED through the display surface DS may be provided to the user.

The display surface DS may include a display area DA and a peripheral area SA adjacent to the display area DA. The display area DA may display an image, and the peripheral area SA may not display an image. The peripheral area SA may surround the display area DA in a plan view and define a border of the electronic device ED printed in a color.

The electronic device ED may include at least one sensor SN and at least one camera CA. The sensor SN and the camera CA may be adjacent to the edge of the electronic device ED. The sensor SN and the camera CA may be disposed in the display area DA adjacent to the peripheral area SA. The sensor SN and the camera CA may be disposed in the second non-folding area NFA2, but the disclosure is not limited thereto, and the sensor SN and the camera may also be disposed in the first non-folding area NFA1.

Light may be transmitted through portions of the electronic device ED on which the sensor SN and the camera CA are disposed to be provided to the sensor SN and the camera CA. For example, the sensor SN may be a proximity light sensor, but the type of sensor SN is not limited thereto. The camera CA may capture an external image. The sensor SN and the camera CA may be provided in plural.

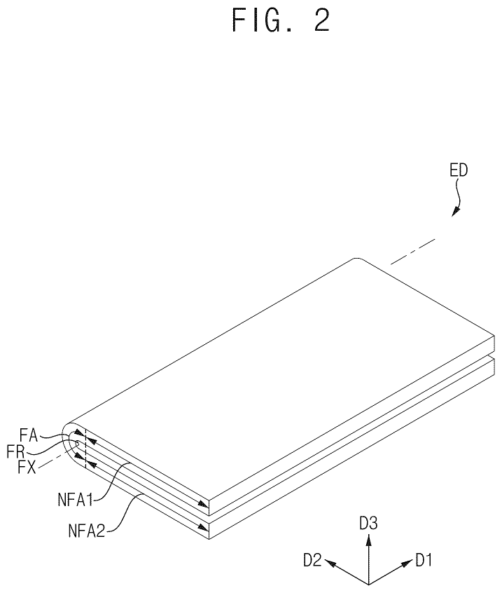

FIG. 2 is a perspective view showing the folded state of the electronic device shown in FIG. 1.

Referring to FIG. 2, the electronic device ED may be a foldable electronic device that can be folded or unfolded. For example, the folding area FA may be bent with respect to a folding axis FX parallel to the first direction D1, such that the electronic device ED may be folded. The folding axis FX may be defined as a long axis parallel to the long side of the electronic device ED.

In case that the electronic device ED is folded, the first non-folding area NFA1 and the second non-folding area NFA2 may face each other, and the electronic device ED may be in-folded so that the display surface DS may not be exposed to the outside. However, the disclosure is not limited thereto. For example, the electronic device ED may be out-folded around the folding axis FX so that the display surface DS may be exposed to the outside.

As shown in FIG. 2, a distance between the first non-folding area NFA1 and the second non-folding area NFA2 may be twice a radius of curvature FR.

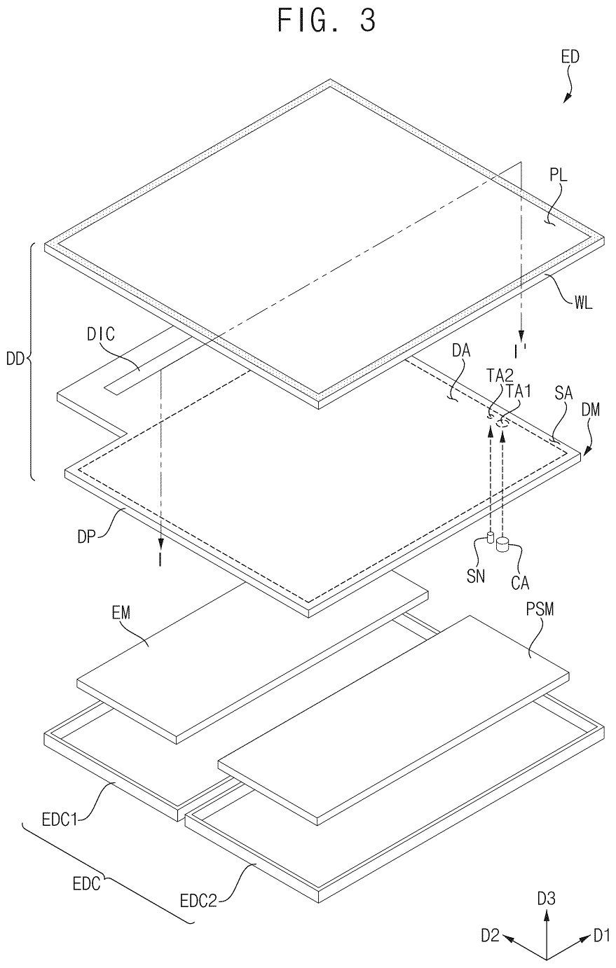

In one embodiment, the radius of curvature FR of the electronic device ED may be in a range of about 0.5 mm to about 2 mm. In an embodiment, the radius of curvature FR may be in a range of about 0.5 mm to about 1.5 mm. However, the disclosure is not limited thereto. FIG. 3 is an exploded perspective view of the electronic device shown in FIG. 1.

Referring to FIG. 3, the electronic device ED may include a display device DD, an electronic module EM, a power module PSM, and a case EDC. Although not separately shown, the electronic device ED may further include a mechanical structure (e.g., a hinge) for controlling the folding operation of the display device DD.

The display device DD may generate images and detect external inputs. The display device DD may include a window layer WL and a display module DM.

The window layer WL may provide a front surface of the electronic device ED. The window layer WL may be disposed on the display module DM to protect the display module DM. Specifically, the window layer WL may protect the electronic device ED from external impact and scratch by attaching a protective film PL to a top surface of the window layer. The window layer WL may transmit light generated in the display module DM and provide light to the user.

The display module DM may include a display panel DP. Although only the display panel DP is shown in FIG. 3 among stacked structures of the display module DM, the display module DM may further include multiple components disposed above and below the display panel DP.

The display panel DP may include the display area DA and the peripheral area SA corresponding to the display area DA and the peripheral area SA of the electronic device ED.

A first transparent area TA1 and a second transparent area TA2 may be defined in the display panel DP. The first transmission area TA1 and the second transmission area TA2 may have a higher light transmittance than the surrounding area. For example, the camera CA may be disposed under the first transmission area TA1, and the sensor SN may be disposed under the second transmission area TA2. Light transmitted through the first and second transmission areas TA1 and TA2 may be provided to the camera CA and the sensor SN.

The display module DM may include a data driver DIC disposed on the peripheral area SA of the display panel DP. The data driver DIC may be manufactured in the form of an integrated circuit chip and mounted on the peripheral area SA. However, the disclosure is not limited thereto, and the data driver DIC may be mounted on a flexible circuit board connected to the display panel DP.

The electronic module EM and the power module PSM may be disposed below the display device DD. Although not shown, the electronic module EM and the power module PSM may be connected to each other through a separate flexible circuit board. The electronic module EM may control an operation of the display device DD. The power module PSM may supply power to the electronic module EM.

The case EDC may accommodate the display device DD, the electronic module EM, and the power module PSM. The case EDC may protect the display device DD, the electronic module EM, and the power module PSM. The case EDC may include first and second cases EDC1 and EDC2 to fold the display device DD. The first and second cases EDC1 and EDC2 may extend in the first direction D1 and be arranged in the second direction D2.

Although not shown, the electronic device ED may further include a hinge structure for connecting the first and second cases EDC1 and EDC2.

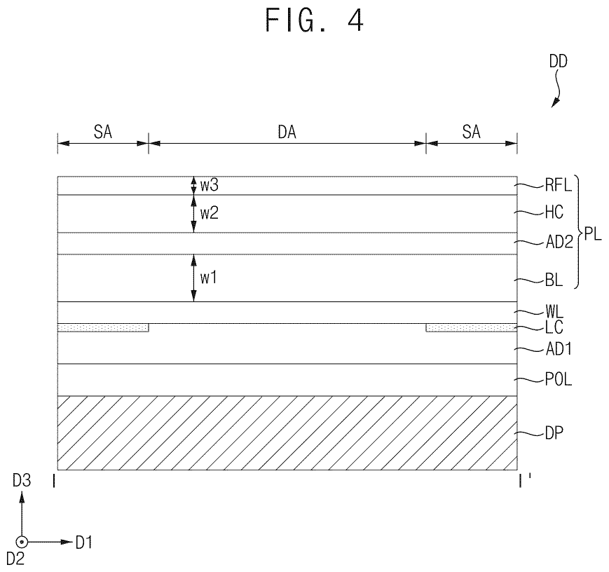

FIG. 4 is a schematic cross-sectional view of a display device shown in FIG. 3 taken along line I-I′.

Referring to FIG. 4, the display device DD may include the display panel DP, a polarization layer POL, a first adhesive layer AD1, a light blocking layer LC, the window layer WL, and the protective film PL.

The display panel DP may be disposed at the bottom of the display device DD. The display panel DP may include a display area DA that displays an image and a peripheral area SA adjacent to the display area DA.

The polarization layer POL may be disposed on the display panel DP. The polarization layer POL may change the optical axis of light emitted from the display panel DP. The polarization layer POL and the display panel DP may have substantially the same size in a plan view. The polarization layer POL may be a single layer or multiple layers including a polarizing film and a retardation film. However, the disclosure is not limited thereto.

The first adhesive layer AD11I may be disposed on the polarizing layer POL. The first adhesive layer ADI may include a resin that is photocurable. In case that a trace amount of the photoinitiator contained in the resin receives light, the photopolymerization reaction may start, and a monomer and an oligomer, which are main components of the resin, may be instantaneously formed and cured. The polarizing layer POL and the window layer WL may be attached through the first adhesive layer AD1.

The light blocking layer LC may be disposed on at least a portion of the first adhesive layer AD1. The light blocking layer LC may be disposed in the peripheral area SA. The light blocking layer LC may prevent a driver that drives the display panel DP from being visible to the outside. The light blocking layer LC may be composed of a single layer. In another embodiment, the light blocking layer LC may include multiple layers including a same thickness or different thicknesses.

The window layer WL may be disposed on the first adhesive layer AD1.

The window layer WL may include a transparent material, for example, glass or plastic. Specifically, the window layer WL may be ultra-thin glass or a transparent polyimide film with a width less than or equal to about 0.3 mm in the third direction D3. For example, the window layer WL may be composed of a single layer. In another embodiment, the window layer WL may include multiple layers. However, the disclosure is not limited thereto.

The protective film PL may be disposed on the window layer WL. The protective film PL may include a base layer BL, a second adhesive layer AD2, a hard coating layer HC, and a refractive layer RFL.

In one embodiment, the protective film PL may have a reflectance of less than or equal to about 2% for light having a wavelength of about 550 nm. In an embodiment, the protective film PL may have a reflectance in a range of about 0.5% to about 2% for light having a wavelength of about 550 nm. In case that the reflectance is higher than the above range, visibility may be reduced when a user uses the display device DD due to reflection of external light. However, the disclosure is not limited thereto.

In one embodiment, an elastic strain of the protective film PL may be in a range of about 7% to about 30%. In an embodiment, the clastic strain of the protective film PL may be in a range of about 8% to about 30%. In an embodiment, the clastic strain of the protective film PL may be in a range of about 8% to about 25%. In case that the elastic strain of the protective film PL is less than the above range, cracks and etc may occur when using the display device DD. However, the disclosure is not limited thereto.

In one embodiment, the radius of curvature (FR in FIG. 2) of the protective film PL may be less than or equal to about 2 mm. In an embodiment, the radius of curvature (FR in FIG. 2) of the protective film PL may be in a range of about 0.5 mm to about 2 mm. The foldable performance of the display device DD may be further improved by the radius of curvature (FR in FIG. 2). However, the disclosure is not limited thereto.

The base layer BL may include a plastic. For example, the base layer BL may include PolyEthylene Terephthalate (PET), PolyEthylene Naphthalate (PEN), Polyether Sulfone (PES), PolyImide (PI), PolyARylate (PAR), PolyCarbonate (PC), PolyMethyl MethAcrylate (PMMA), COC (CycloOlefin Copolymer), a polyether block amide (PEBA) resin, etc. These may be used alone or in combination with each other. However, the disclosure is not limited thereto.

In one embodiment, a first thickness W1 of the base layer BL in the third direction D3 may be in a range of about 30 μm to about 150 μm. In an embodiment, the first thickness W1 of the base layer BL in the third direction D3 may be in a range of about 50 μm to about 120 μm. However, the disclosure is not limited thereto.

The second adhesive layer AD2 may be disposed on the base layer BL. The second adhesive layer AD2 and the first adhesive layer AD1 may have substantially same functions and include a same material.

The hard coating layer HC may be disposed on the second adhesive layer AD2. Specifically, the hard coating layer HC may be attached to the base layer BL through the second adhesive layer AD2. The hard coating layer HC may protect a surface of the window layer WL, protect the window layer WL from physical and chemical damage, and improve mechanical properties of the window layer WL. The hard coating layer HC may include polyimide, polycarbonate, polyethersulfone, polyethylene naphthalate, polyphenylene sulfide, liquid crystal polymer (LCP), polymethyl methacrylate, acrylic polymer, epoxy polymer, etc. These may be used alone or in combination with each other. However, the disclosure is not limited thereto.

In one embodiment, a second thickness W2 of the hard coating layer HC in the third direction D3 may be in a range of about 3 um to about 10 um. In an embodiment, the second thickness W2 of the hard coating layer HC in the third direction D3 may be in a range of about 5 μm to about 8 μm. However, the disclosure is not limited thereto.

The refractive layer RFL may be disposed on the hard coating layer HC. The refractive layer RFL may have a low reflectance, and an increase in reflectance may be minimized or eliminated even in a high temperature or high humidity environment. Accordingly, reliability and external light blocking effect of the display device DD may be excellent.

In one embodiment, the refractive layer RFL may include an organic compound including difluorocarbene (—CF2) and trifluoromethyl group (—CF3). For example, the refractive layer RFL may include an organic compound having a molar ratio of about CF2:CF3=2:1. For example, the refractive layer RFL may include dodecafluoroheptyl acrylate (DFHA) represented by the following Formula 1.

For example, the refractive layer RFL may be formed by crosslinking two or more organic compounds including DFHA represented by the following Formula 1.

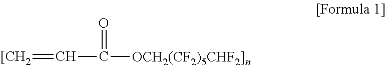

In Formula 1, n may be one of 6, 8, 10, and 12. In an embodiment, n may be one of 8, 10 and 12. In an embodiment, n may be 8.

With respect to the trifluoromethyl group (—CF3), some ends of the monomers of the organic compound represented by Formula 1 may be a trifluoromethyl group (—CF3), and other ends of the monomers of the organic compound represented by Formula 1 may not be a trifluoromethyl group (—CF3).

In one embodiment, a third thickness W3 of the refractive layer RFL in the third direction D3 may be in a range of about 50 nm to about 150 nm. In an embodiment, the third thickness W3 of the refractive layer RFL in the third direction D3 may be in a range of about 70 nm to about 130 nm. However, the disclosure is not limited thereto.

In one embodiment, the refractive layer RFL may be a single layer. For example, functional layers such as an anti-fingerprint layer may not be disposed on the refractive layer RFL. However, the disclosure is not limited thereto. The refractive layer RFL may include a layer in which multiple refractive layers RFL are alternately stacked each other.

In one embodiment, the refractive layer RFL may include a crosslinking agent. For example, the crosslinking agent may be zinc diacrylate. In another embodiment, the crosslinking agent may be dicumyl peroxide, benzoyl peroxide, lauryl peroxide, t-butyl cumyl peroxide, di(t-butylperoxyisopropyl) benzene, 2,5-dimethyl-2,5-di(t-butyl peroxy) hexane, di-t-butyl peroxide, 1,1-bis (t-butylperoxy)-3,3,5-trimethyl cyclohexane, 1,1-bis (t-butylperoxide) Oxy) cyclohexane, t-butylperoxy maleic acid, t-butylperoxy-3,3,5-trimethylhexanoate, cyclohexanone peroxide, t-butylperoxy aryl carbonate, t-butylperoxy iso Propyl carbonate, 2,5-dimethyl-2,5-di(benzoylperoxy) hexane, 2,2-bis(t-butylperoxy) octane, t-butylperoxy acetate, 2,2-bis (t-Butylperoxy) butane, t-butylperoxybenzoate, n-butyl-4,4-bis(t-butylperoxybutylperoxy) valerate, di-t-butylperoxy isophthalate, methyl ethyl ketone oxide, α,α′-bis (t-butylperoxy-m-isopropyl) benzene, di-isopropylbenzene hydroperoxide, di-t-butyl peroxide, 2,5-dimethyl-2, etc. These may be used alone or in combination with each other. However, the disclosure is not limited thereto.

In one embodiment, a water contact angle, which is the internal angle formed between the refractive layer RFL and water, may be greater than or equal to about 90 degrees. In an embodiment, the water contact angle of the refractive layer RFL may be in a range of about 100 degrees to about 125 degrees. Accordingly, the refractive layer RFL may have resistance to contamination and may perform an anti-fingerprint function. In other words, in case that the refractive layer RFL has a water contact angle smaller than the above range, it may be vulnerable to contamination or the anti-fingerprint function may be deteriorated. However, the disclosure is not limited thereto.

Below, the effects of the disclosure according to comparative examples and examples will be described.

### Example 1, Comparative Example 1 and Comparative Example 2

Table 1 below shows a state of a refractive layer RFL including DFHA formed with a thickness of 90 nm in the protective film PL disposed on the window layer WL according to Example 1. Table 1 below also shows a state of a refractive layer including ZrOₓ, SiO, Nb₂O₅ and SiO₂ formed in the protective film disposed on the window layer according to Comparative Examples 1 and 2.

Referring to Table 1 below, in Example 1, a protective film PL including a base layer (thickness: 65 um) including polyethylene terephthalate (PET), a hard coating layer (thickness: 5 um) disposed on the base layer, and a refractive layer (thickness: 90 nm) disposed on the hard coating layer and including DFHA was formed.

In Comparative Example 1, a protective film including a base layer (thickness: 50 um) including polyethylene terephthalate (PET), a hard coating layer (thickness: 5 um) disposed on the base layer, and a refractive layer disposed on the hard coating layer and including ZrOx (thickness: 110 nm) and SiO (thickness: 80˜90 nm) was formed.

In Comparative Example 2, a protective film including a base layer (thickness: 50 um) including polyethylene terephthalate (PET), a hard coating layer (thickness: 5 um) disposed on the base layer, and a refractive layer including Nb₂O₅ (thickness: 11 nm), SiO₂ (thickness: 25 nm), Nb₂O₅ (thickness: 105 nm), and SiO₂ (thickness: 68 nm) was formed.

TABLE 1

| | Comparative | Comparative | |
|---|---|---|---|
| | Example 1 | Example 2 | Example 1 |
| base layer and hard | PET(50 um)/ | PET(50 um)/ | PET(65 um)/ |
| coating layer | HC(5 um) | HC(5 um) | HC(5 um) |
| refractive layer | ZrOₓ(110 nm)/ | Nb2O₅(11 nm)/ | DFHA(90 nm) |
| | SiO(80~90 nm) | SiO₂(25 nm)/ | |
| | | Nb2O₅(105 nm)/ | |
| | | SiO₂(68 nm) | |

Table 2 below shows an elastic strain of the protective film formed according to Example 1, Comparative Example 1, and Comparative Example 2 and reflectance of light having a wavelength of about 550 nm. Effects of the protective film PL described in the disclosure may be confirmed through Table 2 below.

Referring to Table 2 below, it may be confirmed that in Comparative Example 1, the elastic strain of the protective film is 4.5% and the reflectance of light having a wavelength of about 550 nm is 1.33%.

In Comparative Example 2, it may be confirmed that the elastic strain of the protective film is 2% and the reflectance for light with a wavelength of about 550 nm is 0.25%.

On the other hand, in Example 1, it may be confirmed that the elastic strain of the protective film was 8.2% and the reflectance for light with a wavelength of about 550 nm was 1.35%.

TABLE 2

| | Comparative | Comparative | |
|---|---|---|---|
| | Example 1 | Example 2 | Example 1 |
| Elastic strain(%) | 4.5 | 2 | 8.2 |
| reflectance | 1.33 | 0.25 | 1.35 |
| (%)(550 nm) | | | |

According to the experiment, it may be confirmed that in the case of the protective film including DFHA and a refractive layer formed with a thickness of 90 nm, the elastic strain is higher than the elastic strain of Comparative Examples 1 and 2, and the reflectance is also measured within 2%.

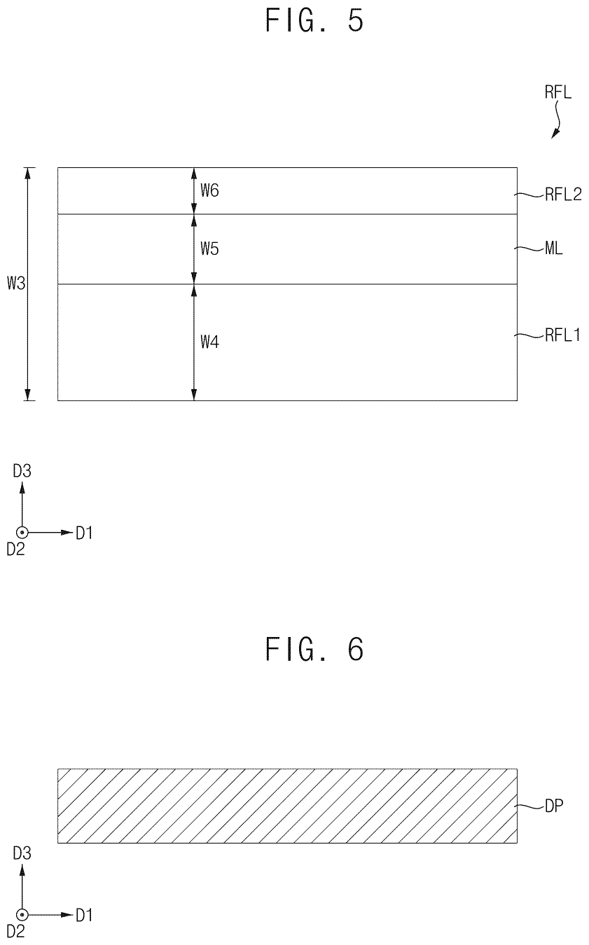

FIG. 5 is a schematic cross-sectional view showing an embodiment of the refractive layer shown in FIG. 4.

Referring to FIGS. 4 and 5, in one embodiment, the refractive layer RFL may include an organic compound such as difluorocarbene (—CF2), trifluoromethyl group (—CF3), and ether group (—O—). For example, the refractive layer RFL may include an organic compound such as dodecafluoroheptyl acrylate (DFHA) and perfluoropolyether (PFPE).

In one embodiment, the refractive layer RFL may include at least two layers. For example, the refractive layer RFL may include a first refractive layer RFL1, a mixed layer ML, and a second refractive layer RFL2. The first refractive layer RFL1 may include DFHA represented by Formula 1, as described with reference to FIG. 4. For example, the first refractive layer RFL1 may be formed by crosslinking two or more organic compounds including DFHA represented by the Formula 1.

The second refractive layer RFL2 may be disposed on the first refractive layer RFL1. In one embodiment, the second refractive layer RFL2 may include PFPE represented by Formula 2 below. For example, the second refractive layer RFL2 may include an ether group. As the second refractive layer RFL2 includes the ether group, the wear resistance of the refractive layer RFL2 may be increased.

For example, the second refractive layer RFL2 may be formed by crosslinking two or more organic compounds including PFPE represented by the following Formula 2.

[C₃F₇—(O—CF₂—CF₂—CF₂—(₁₂·C₂F₄—]ₙ [Formula 2]

In Formula 2, n may be one of 10, 12, 14, and 16. In an embodiment, n may be 12. However, the disclosure is not limited thereto.

The mixed layer ML may be disposed between the first refractive layer RFL1 and the second refractive layer RFL2 in cross sectional view. The mixed layer ML may be a layer in which a portion of the first refractive layer RFL1 and a portion of the second refractive layer RFL2 are mixed. Since the mixed layer ML is disposed between the first refractive layer RFL1 and the second refractive layer RFL2, the second refractive layer RFL2 may be stably disposed on the first refractive layer RFL1 by coupling to the mixed layer ML.

For example, the mixed layer ML may be formed by crosslinking two or more organic compounds including DFHA represented by Formula 1 and two or more organic compounds including PFPE represented by Formula 2.

In one embodiment, a sum of a thicknesses of the first refractive layer RFL1, the mixed layer ML, and the second refractive layer RFL2 in the third direction may be the third thickness W3. For example, the third thickness W3 may be a sum of a fourth thickness W4 of the first refractive layer RFL1 in the third direction D3, a fifth thickness W5 of the mixed layer ML in the third direction D3, and a sixth thickness W6 of the second refractive layer RFL2 in the third direction D3.

For example, the fourth thickness W4 may be in a range of about 60 nm to about 80 nm. The fifth thickness W5 may be in a range of about 10 nm to about 20 nm. The sixth thickness W6 may be in a range of about 10 nm to about 20 nm. However, the disclosure is not limited thereto. As the first refractive layer RFL1, the mixed layer ML, and the second refractive layer RFL2 of the refractive layer RFL have the fourth thickness W4, the fifth thickness W5, and the sixth thickness W6 respectively, the water contact angle of the refractive layer RFL may increase, thereby increasing wear resistance and reducing reflectance to external light.

In one embodiment, in the refractive layer RFL, the dodecafluoroheptyl acrylate and the perfluoropolyether may have a mass ratio of about 9:1. For example, the refractive layer RFL may have a mass ratio of about 9:1 by sequentially depositing the dodecafluoroheptyl acrylate and the perfluoropolyether. Accordingly, the content of fluorine included in the refractive layer RFL may increase compared to an embodiment that the refractive layer RFL is a single layer. As a fluorine content of the refractive layer RFL increases, the wear resistance of the refractive layer RFL against external impact may increase.

In one embodiment, the refractive layer RFL may include carbon atom @, oxygen atom (O), and fluorine atom (F). The fluorine may account for greater than or equal to about 20% of the total mass of the refractive layer RFL. For example, a mass ratio of fluorine in the refractive layer RFL may be greater than or equal to about 20%. For example, the fluorine content of the refractive layer RFL may be greater than or equal to about 20% on each of the surface and interior of the refractive layer RFL. In case that the refractive layer RFL includes fluorine in a mass ratio of greater than or equal to about 20%, the wear resistance of the refractive layer RFL may be increased.

In one embodiment, a mass of the carbon included in the second refractive layer RFL2 divided by a mass of the fluorine included in the second refractive layer RFL2 may be less than or equal to about 3.5. A mass of oxygen included in the second refractive layer RFL2 divided by a mass of fluorine included in the second refractive layer RFL2 may be less than or equal to about 0.1. As the mass of the carbon included in the second refractive layer RFL2 divided by the mass of the fluorine included in the second refractive layer RFL2 is less than or equal to about 3.5, and the mass of the oxygen included in the second refractive layer RFL2 divided by the mass of the fluorine contained in the second refractive layer RFL2 is less than or equal to about 0.1, for example, as the mass ratio of the fluorine increases, wear resistance of the second refraction layer RFL2 against external impacts, etc. may be increased. Below, effects of the disclosure according to Comparative Example 3 and Example 2 will be described.

### Example 2 and Comparative Example 3

Referring to Table 3 below, in the protective film PL formed on the window layer WL and including the refractive layer RFL according to Example 2, a refractive layer RFL including the dodecafluoroheptyl acrylic n=8 and the perfluoropolyether n=12 was formed. A mixed layer formed by mixing the first refractive layer RFL1 and the second refractive layer RFL2 is formed between the first refractive layer RFL1 and the second refractive layer RFL2.

In Example 2, a protective film PL including a base layer (thickness: 65 μm) including polyethylene terephthalate (PET), a hard coating layer (thickness: 5 μm) formed on the base layer, a first refractive layer (thickness: 90 nm) formed on the hard coating layer including dodecafluoroheptyl acrylate, and a second refractive layer (thickness: 10 nm) including perfluoropolyether was formed.

In Comparative Example 3, a protective film PL including a base layer (thickness: 65 μm) including polyethylene terephthalate (PET), a hard coating layer (thickness: 5 μm) formed on the base layer, a first refractive layer (thickness: 100 nm) formed on the hard coating layer including dodecafluoroheptyl acrylate, and a second refractive layer (thickness: 30 nm) including perfluoropolyether was formed.

TABLE 3

| | Comparative Example 3 | Example 2 |
|---|---|---|
| base layer and hard | PET(50 um)/HC(5 um) | PET(50 um)/HC(5 um) |
| coating layer | | |
| first refractive layer | DFHA(100 nm) | DFHA(90 nm) |
| second refractive | PFPE(30 nm) | PFPE(10 nm) |
| layer | | |
| Elastic strain(%) | 12.0 | 12.5 |
| reflectance | 6.53 | 5.45 |
| (%)(550 nm) | | |
| water contact angle (°) | 116.9 | 131.1 |

Referring to Table 3, the elastic strain of the protective film formed according to Example 2 and Comparative Example 3, reflectance of light having a wavelength of about 550 nm, and a water contact angle were measured.

As a result, in Comparative Example 3, it may be confirmed that the elastic strain is about 12%, the reflectance of light having a wavelength of about 550 nm is about 6.53%, and the water contact angle is about 116.9 degrees.

On the other hand, in Example 2, it may be confirmed that the elastic strain of the protective film is about 12.5%, the reflectance of light having a wavelength of about 550 nm is about 5.45%, and the water contact angle is about 131.1 degrees.

According to the experiment, it may be confirmed in case that dodecafluoroheptyl acrylate and perfluoropolyether are included in a mass ratio of about 9:1, the elastic strain is greater, the reflectance of light having a wavelength of about 550 nm is lower, and the water contact angle is further improved.

Table 4 below shows the mass ratios of carbon, fluorine, and oxygen included in the refractive layer RFL formed according to Example 2 and Comparative Example 3. Specifically, the mass ratios of carbon, fluorine, and oxygen in the surface and inside of the refractive layer RFL are shown.

TABLE 4

| | Comparative Example 3 | | Example 2 | |
|---|---|---|---|---|
| | surface | inside | surface | inside |
| carbon(%) | 76.51 | 79.82 | 68.90 | 75.00 |
| fluorine (%) | 20.60 | 17.81 | 29.20 | 23.03 |
| oxygen(%) | 2.89 | 2.37 | 1.89 | 1.97 |
| carbon/fluorine (mass | 3.714 | 4.483 | 2.359 | 3.257 |
| ratio) | | | | |
| Oxygen/fluorine(mass | 0.141 | 0.133 | 0.065 | 0.086 |
| ratio) | | | | |

Referring to Table 4, it may be confirmed that in Comparative Example 3, the mass ratio of fluorine contained in the refractive layer RFL was 20.6% on the surface and 17.81% on the inside. On the other hand, in Example 2, it may be confirmed that the mass ratio of fluorine contained in the refractive layer RFL was 29.2% on the surface and 23.03% on the inside. In Example 2, it may be confirmed that the mass ratio of fluorine contained in each of the surface and the inside of the refractive layer RFL is greater than the mass ratio of fluorine contained in each of the surface and the inside of the refractive layer RFL in Comparative Example 3.

As shown in Table 3 and Table 4, it may be confirmed that the protective film containing a refractive layer containing dodecafluoroheptyl acrylate and perfluoropolyether in a mass ratio of about 9:1 has a greater fluorine-containing mass ratio than the protective film containing a refractive layer containing dodecafluoroheptyl acrylate and perfluoropolyether in a mass ratio of about 10:3.

As a result, it may be confirmed that the elastic strain, reflectance, and contact angle of the refractive layer RFL may be improved as the refractive layer RFL includes dodecafluoroheptyl acrylate and perfluoropolyether in a mass ratio of about 9:1.

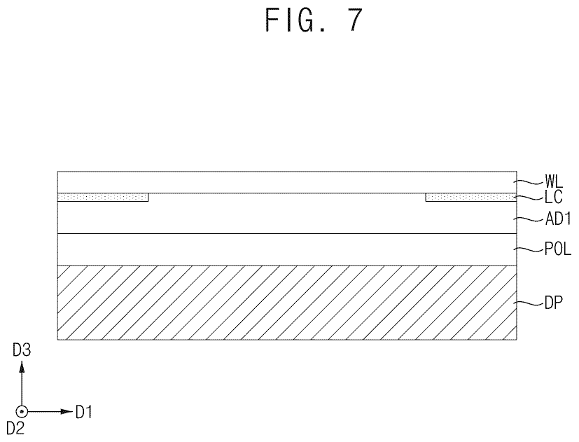

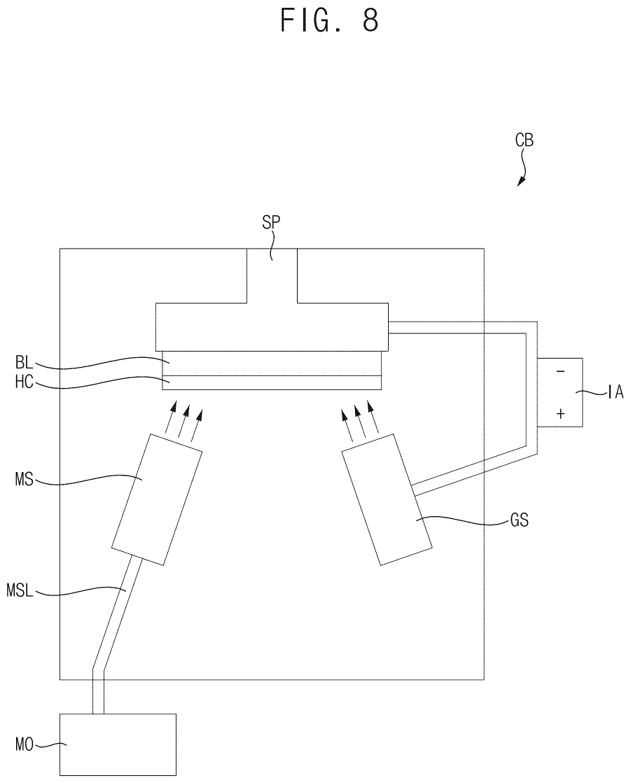

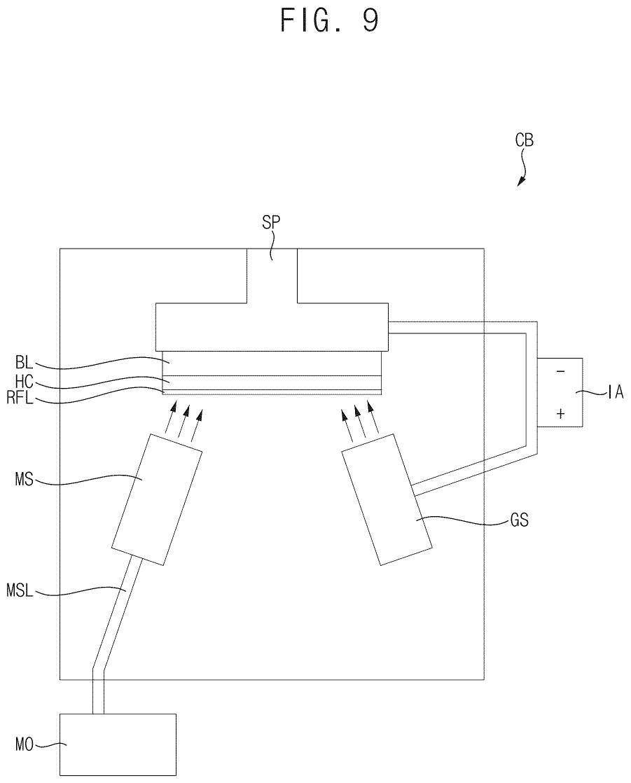

FIGS. 6, 7, 8, and 9 are schematic views for explaining a method of manufacturing display device of FIG. 4. Specifically, FIGS. 8 and 9 are schematic views for explaining the manufacturing process of the protective film of FIG. 4 using a vacuum deposition apparatus.

Referring to FIGS. 6 and 7, a polarization layer POL may be formed on the display panel DP. The polarization layer POL may cover the display panel DP. The polarization layer POL may be formed of a single layer or multiple layers including a polarizing film and a retardation film. However, the disclosure is not limited thereto.

The first adhesive layer ADI may be formed on the polarization layer POL. The first adhesive layer ADI may include a photo-curable resin. In case that the photoinitiator included in a small amount in the resin is exposed to light, a photopolymerization reaction may be initiated, and the monomers and oligomers, which are the main components of the resin, may instantaneously form a polymer and harden.

The light blocking layer LC may be formed on at least a portion of the first adhesive layer AD1. The light blocking layer LC may be formed in a peripheral area (e.g., peripheral area SA in FIG. 4).

The window layer WL may be formed on the first adhesive layer AD1. For example, the window layer WL may be attached to the polarization layer POL by the first adhesive layer AD1. The window layer WL may include a transparent material such as glass or plastic. For example, the window layer WL may be composed of a single layer.

As a result, the display panel DP, the polarization layer POL, the first adhesive layer ADI, the light blocking layer LC, and the window layer WL may be formed sequentially.

Referring further to FIGS. 8 and 9, a vacuum deposition apparatus may include a chamber CB, a support portion SP, an ion accelerator IA, a gas supply portion GS, a monomer storage portion MO, a monomer supply line MSL, and a monomer supply portion MS.

The chamber CB may protect the protective film PL by providing a sealed environment from the outside and may provide a space in which the protective film PL is stacked. For example, the chamber CB may have a vacuum pressure (e.g., about 10 Torr to about 200 Torr) that is lower than the normal pressure (e.g., about 1 atmosphere or about 760 Torr). However, the disclosure is not limited thereto.

The support part SP may be disposed in the chamber CB. The support part SP may provide a space where the protective film PL may be disposed. The support part SP may be an electrostatic chuck that adsorbs the protective film PL using electrostatic force, or a device that supports the protective film PL in a manner such as mechanical clamping.

For example, the base layer BL and the hard coating layer HC may be formed by sequentially stacking on the support part SP.

The gas supply portion GS may supply a gas into the chamber CB. The gas may include an inert gas. For example, the gas may include helium, neon, argon, etc. However, the disclosure is not limited thereto. The gas may be used in combination with oxygen or the like as needed.

The ion accelerator IA may accelerate the gases provided to the chamber CB. For example, a bias voltage may be applied to the hard coating layer HC to allow the gases to collide with the hard coating layer HC.

In one embodiment, the dodecafluoroheptyl acrylate may be cross-linked on the hard coating layer HC by the ion accelerator IA. For example, the gas accelerated by the ion accelerator IA and the dodecafluoroheptyl acrylate organic compound may cross-link on the hard coating layer HC due to impact.

In another embodiment, the dodecafluoroheptyl acrylate and the perfluoropolyether may be sequentially cross-linked on the hard coating layer HC by the ion accelerator IA. For example, the dodecafluoroheptyl acrylate may be deposited first on the hard coating layer HC, and the perfluoropolyether may be deposited on the dodecafluoroheptyl acrylate. Accordingly, the refractive layer RFL of FIG. 5 including a first refractive layer formed of the dodecafluoroheptyl acrylate and a second refractive layer formed of the perfluoropolyether on the first refractive layer may be formed.

During forming of the refractive layer RFL by the ion accelerator IA, the chamber CB may remain dry without moisture. Accordingly, the refractive layer RFL may be formed in a dry state by vacuum deposition.

In one embodiment, an ion acceleration voltage of the ion accelerator IA may be less than or equal to about 500V. In an embodiment, the ion acceleration voltage of the ion accelerator IA may be in a range of about 100V to about 500V. In case that the ion acceleration voltage of the ion accelerator IA exceeds about 500V, a water repellency of the protective film PL may be reduced. In case that the ion acceleration voltage of the ion accelerator IA is less than about 100V, an adhesion of the protective film PL may decrease. However, the disclosure is not limited thereto.

The monomer storage portion MO, the monomer supply line MSL, and the monomer supply portion MS may provide monomers on the hard coating layer HC to form the protective film PL that is the object. The monomer may be polymerized on the hard coating layer HC to form the refractive layer RFL. For example, the monomer storage portion MO may contain the monomer, and the monomer may move along the monomer supply line MSL and be provided into the chamber CB through the monomer supply portion MS.

In one embodiment, the base layer BL and the hard coating layer HC may be formed on the support part SP, and the gas provided from the gas supply part GS on the hard coating layer HC may be ion-accelerated to be polymerized on the hard coating layer HC together with the monomer. The gas may form the refractive layer RFL with the monomer by applying to the hard coating layer HC. For example, the ion-accelerated gas may be polymerized well in case that the monomer is formed on the hard coating layer HC.

The protective film PL of FIG. 4 may be formed according to the process shown in FIGS. 8 and 9. The protective film PL of FIG. 4 formed according to FIGS. 8 and 9 may be attached to the window layer WL. As a result, the display device DD shown in FIG. 4 may be manufactured.

Referring to FIGS. 1 to 9, the display device DD according to embodiments of the disclosure may include a base layer BL, a hard coating layer HC disposed on the base layer BL, a protective film PL disposed on the hard coating layer HC and including an organic compound including difluorocarbene (—CF2) and trifluoromethyl group (—CF3).

Accordingly, resistance to elastic strain due to external impact, etc. may be improved, the elastic strain of the protective film PL may increase, and the reflectance of light may decrease. For example, in case that the protective film PL is attached to the display panel DP, external impact and visibility of the electronic device ED may be improved when using the electronic device ED.

The disclosure may be applied to the display device and the electronic device including the same. For example, the disclosure may be applied to high-resolution smartphones, mobile phones, smart pads, smart watches, tablet PCs, vehicle navigation systems, televisions, computer monitors, laptops, etc.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display device comprising:
a display panel that displays images;
a window layer disposed on the display panel; and
a protective film disposed on the window layer, and including:
a base layer facing the window layer;
a hard coating layer disposed on the base layer; and
a refractive layer disposed on the hard coating layer and including an organic compound including difluorocarbene (—CF₂) and trifluoromethyl group (—CF₃).

2. The display device of claim 1, wherein a molar ratio of the difluorocarbene (—CF₂) and the trifluoromethyl group (—CF₃) is about 2:1.

3. The display device of claim 1, wherein the organic compound includes dodecafluorohepttyl acrylate (DFHA) represented by Formula 1 below: 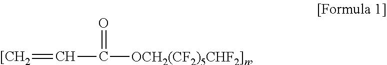
wherein, n is one of 6, 8, 10, and 12.

4. The display device of claim 1, wherein a thickness of the refractive layer is in a range of about 70 nm to about 130 nm.

5. The display device of claim 1, wherein the refractive layer is a single layer.

6. The display device of claim 1, wherein the refractive layer further includes a crosslinking agent.

7. The display device of claim 6, wherein the crosslinking agent is zinc diacrylate (ZDA).

8. The display device of claim 1, wherein a reflectance of the protective film is less than or equal to about 2% for light with a wavelength of about 550 nm.

9. The display device of claim 1, wherein an elastic strain of the protective film is in a range of about 7% to about 30%.

10. The display device of claim 1, wherein a water contact angle of the refractive layer is in a range of about 100 degrees to about 125 degrees.

11. The display device of claim 1, wherein the organic compound further includes an ether group (—O).

12. The display device of claim 11, wherein the organic compound includes DFHA represented by Formula 1 below and perfluoropolyether (PFPE) represented by Formula 2 below: 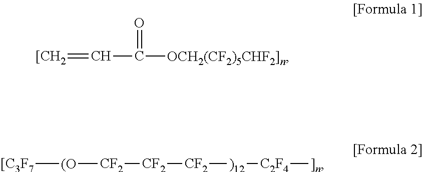
wherein, in Formula 1, n is one of 6, 8, 10, and 12, and in Formula 2, n is one of 10, 12, 14, and 16.

13. The display device of claim 12, wherein the refractive layer comprises:
a first refractive layer including DFHA;
a second refractive layer disposed on the first refractive layer and including PFPE; and
a mixed layer disposed between the first refractive layer and the second refractive layer and including DFHA and PFPE.

14. A method of manufacturing a display device, the method comprising:
forming a display panel that displays an image;
forming a window layer on the display panel;
forming a protective film including
a base layer on the window layer;
a hard coating layer on the base layer; and
a refractive layer on the hard coating layer and including an organic compound including difluorocarbene (—CF₂) and trifluoromethyl group (—CF₃); and
attaching the protective film to the window layer.

15. The method of claim 14, wherein a molar ratio of the difluorocarbene (—CF₂) and the trifluoromethyl group (—CF₃) is about 2:1.

16. The method of claim 14, wherein the organic compound includes dodecafluorohepttyl acrylate (DFHA) represented by Formula 1 below: 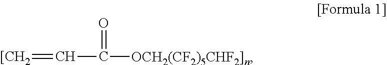
wherein, n is one of 6, 8, 10, and 12.

17. The method of claim 15, wherein a reflectance of the protective film is less than or equal to about 2% for light with a wavelength of about 550 nm.

18. The method of claim 15, wherein in the forming of the protective film, the refractive layer is formed by a vacuum deposition method.

19. The method of claim 18, wherein the forming of the protective film includes:
mounting the base layer and the hard coating layer on a substrate in a vacuum chamber,
supplying a gas including an argon and an organic compound including the difluorocarbene (—CF₂) and the trifluoromethyl group (—CF₃) to the vacuum chamber;
ionizing and accelerating the gas; and
forming the refractive layer by impacting the gas with the organic compound on the base layer and the hard coating layer.

20. The method of claim 19, wherein in the ionizing and accelerating of the gas, an acceleration voltage of the gas is in a range of about 100V to about 500V.
